(19) United States
(12) Patent Application Publication
(10) Pub. No.: US 2021/0213774 A1
(43) Pub. Date: Jul. 15, 2021

(54) Floor tile scoring-cutting guide

(71) Applicant: Gregory L. Meahl, Covina, CA (US)

(72) Inventor: Gregory L. Meahl, Covina, CA (US)

(21) Appl. No.: 16/501,507

(22) Filed: Apr. 22, 2019

(51) Int. Cl. B43L 7/027; E04F 21/00; B25H 7/02

(52) U.S. Cl. CPC B43L 7/0275; B25H 7/02; E04F 21/0076

(57) ABSTRACT

A device to be used as tool creating a straightedge for scoring or cutting VCT (vinyl composition tile) or vinyl floor tile, comprising of a triangular plate that has flat and smooth side surface edges to be used as a straightedge guide to draw a utility knife or other apparatus along the edge. On one of the right angle sides of said triangular plate and face, is an elongated bar fence that extends at ninety-degree angle outwardly from said triangular plate and face. An optional T-bar fence constructed as an integral part of the Floor Tile Cutting—Guide extends only a minimal distance and only far enough from the bottom edge in order that the device can lay flat on a floor tile when it is abutted to the edge or laying off to the side of a floor tile. An optional bar fence on one of the right angle straightedge sides is movable up or down in a ninety-degree angle from said plate and face allowing for the bar fence to lay flat on a floor tile or drop down when off to the side and become a fence that can be abutted to the edge of the floor tile. A preferred embodiment along the fore mentioned sides, there are numeral and corresponding measurement markings indicating distance. Along and by the right angle straightedge side, measurement makings indicate the distance from the bar fence and the edge of the floor tile. Along and by the diagonal straightedge side, measurement makings indicate the distance that the right angle straightedge is from the bottom of floor tile being sized. Such measurement markings on the diagonal are parallel and horizontal to the right angle straightedge side that indicate distance right angle straightedge is from the bottom of the floor tile for easy, quick and accurate measuring for sizing, eliminating the need for a tape measure or other measuring device. With optional recessed, indented or even slightly protruding markings, they are a minimal distance away from the edge allowing for an unobstructed and unencumbered flat and smooth side to guide and to draw a utility knife or other such apparatus along the tool edge. With a preferred embodiment, optionally on the flat face or embedded into the plate of said triangle, is a non slip-slide material made preferably of a rubber material, however optionally it can be made of other material such as vinyl or leather that hold the tool firmly and securely in place preventing movement of tool while using it as a scoring or cutting guide. The tool is constructed preferably of a hard cased aluminum, however optionally it can be constructed of any integrally formed material such as any metal or hard plastic that is solid in nature. It is a tool that is lightweight, compact and easily storable.

### BACKGROUND OF INVENTION

### 1. Field of Invention

This invention relates to the sizing for installation of VCT (Vinyl Composition Tile) or Vinyl floor tiles to fit on outer or inner edges of a room being installed with floor tiles and the tool used to accomplish the task.

### 2. Prior Art

Generally when installing VCT floor tile (vinyl composition tile) or Vinyl floor tiles, another floor tile is used as a scoring-cutting guide. When using another tile, not only is setting up the tile square to the edge of the tile to be sized, time consuming and an effort when drawing a utility knife or other apparatus, the pressure against the edge can cause the tile being used to slip or the pressure downward can cause the tile being scored or cut to move out of place. Another method is to use a framing square of which when used has the same drawbacks of using another tile except when abutting one side of the square against the tile to be sized, the scoring-cutting side is raised above the tile being sized making it an effort to line it up to a mark and can allow the utility knife or other apparatus to waver when lying flat on a tile, it can easily slip and slide out of place. Just to measure and mark the tile is time consuming and effort and as well. Another way, is the use of a framing speed square, once again the T-bar extends to far raising the tool edge above the tile having the same disadvantages as a framing square along with the fact that on the diagonal side measurement markings are for angle and not for placement of size. A speed square, just as a framing square, also can easily slip and move out of place. One other disadvantage is recessed markings or slightly protruding markings extend to the edge hampering the utility knife or other apparatus used along the edge. Many other devices can and are used all of which have their drawbacks. All of these methods are generally the most often ways installers use unless you have a tile cutter which are great for cutting straight across. These are expensive tools and the biggest drawback to them is they are not wide enough to cut on a diagonal or tile larger than twelve inches then you and are forced to go with the other methods I previously pointed out. With this invention and tool, not only is it economical, but it makes cutting on the diagonal much simpler and easier. Most floor installers do not want to pay the money for a tile cutter unless they are installing a vast amount of tile. Now, with this invention, even those that are installing a vast amount of tile or a minimal amount, will desire it whether they have a tile cutter or not. With the non-slip face on this invention being in full contact with tile being sized, the tile moving or the guide moving is no longer an issue. This tool is light weight, compact and can easily be stored unlike a tile cutter.

### BACKGROUND OF INVENTION—OBJECTS AND ADVANTAGES

Accordingly, besides the objects and advantages of the Floor Tile Scoring-Cutting guide described in my patent, several objects and advantages of the patent invention are:

(a) to provide a tool which can be used as a cutting guide for scoring and cutting Vinyl Composition Tile also known as VCT and vinyl floor tiles.

(b) to provide a tool with flat and smooth side edges creating a straightedge in order to provide a guide for a utility knife or other such apparatus.

(c) to provide a tool with a bar fence that can be abutted to the edge and still the face can lay flat on a floor tile with the other right angle square and diagonal side being a straightedge guide to draw a utility knife or other apparatus along the edge.

(d) to provide a tool for scoring or cutting a floor tile straight across at ninety degrees or on the diagonal and as well be used as a general straightedge for all scoring and cutting needs.

(e) to provide a tool that can be used for measuring, marking and sizing of a floor tile.

(f) to provide a tool wherein markings on the diagonal side are arranged parallel and horizontal to the right angle straightedge side that may be used for sizing floor tile without having to use a tape measure for other device.

(g) to provide a tool with numeral and measurement markings providing for easy alignment on a floor tile.

(h) to provide a tool with a superior surface that that can lay flat on a floor tile and be stable and not move when being used as a scoring or cutting guide.

(i) to provide a tool for sizing floor tiles that are larger than twelve inches in size.

Further objects and advantages is to provide a tool and device more versatile to other devices and methods for the installation of floor tiles which is simple use and fairly inexpensive to manufacture and which can obviate the absolute need for a tape measure or other measuring devices. Still further objects and advantages will become apparent and advantages will become apparent from a consideration of the ensuing description and drawings.

### SUMMARY OF INVENTION

With this invention, installing VCT and vinyl floor tile can be accomplished without the drawbacks generally associated with using another floor tile, framing square, speed square or other such apparatus as a scoring or cutting guide. In accordance, a bar fence is on one of the square sides. If a T-bar, it is an integrally constructed as part of the tool and only extends a minimal distance at a ninety-degree angle from plate and face just far enough that the tool can lay flat on a floor tile when abutted to or lying off the edge of a floor tile or an Optional moveable bar fence that is at a ninety-degree angle from the plate and face that allows the entire tool to lay flat on a floor tile or drop down when bar fence is off the edge that can be abutted to a floor tile, thus allowing for either configuration of the tool to easily be aliened to and abutted against the edge of the floor tile to size while the tool lays flat securely in place with full contact on the floor tile. With either T-bar fence or the optional movable fence, the tool can slide freely along the edge of the tile, lining up the other right angle edge and diagonal edge for size or on a mark, can be simply accomplished. With the other right angle and diagonal side, the edges are flat and smooth surfaces creating a straightedge side to draw a utility knife or other such apparatus along the edge. Numeral and corresponding hash markings are placed along the straightedge sides designating measurement. On the right angle straightedge side they designate distance from the edge of bar fence side. On the diagonal side, hash markings are parallel and horizontal from the right angle straightedge scoring-cutting side arranged in a manner in accordance with the length of the bar fence side and determining the actual distance the right angle straightedge side is from the bottom of the floor tile for sizing the tile to be scored or cut and as well can be used as a measuring device. This makes for quick and accurate measurement determining size and the end result and size the tile is to become without the need for a tape measure or other such measuring device. The numerals and corresponding markings on the right angle straightedge side that can be used to determine a stopping point for sizing a cutout around a corner or other obstacle and can be used as well, as a measuring device. In the preferred embodiment, numeral and corresponding hash marks are optionally recessed or indented and set back a minimal distance from the edge of straightedge sides in order to give an unobstructed, unencumbered smooth edge to draw a utility knife or other apparatus along the edge. Another preferred and optional embodiment, on the face or embedded into the plate of the triangle is a non skid-slip material made preferably of a rubber material or other non skid-slip material such as vinyl or leather that holds the tool firmly and securely in place as not to allow utility knife or other apparatus being used, to waver or move from the pressure of drawing the utility knife or other apparatus along the straightedge. Preferably the device is constructed of a hard cased aluminum, however optionally it can be manufactured of any integrally formed material that is solid in nature including plastic or other metal. Not only is this tool time saving but it is economical as well and it makes cutting on the diagonal much simpler and easier. Most floor installers do not want to pay the money for a tile cutter unless they're installing vast amounts of tile or installing tile often. Now with this invention, even those that are installing vast amounts of tile or a minimal amount, will desire it weather they have a tile cutter or not. With the non slip-skid face on this invention the tile moving or the guide moving is no longer an issue as well as lining up on a mark can be precise. The measurement numerals and markings running along the diagonal allow for easy and accurate sizing of the floor tile. With the measurement markings, the need for a tape measure or other measuring device is not critical and marking the tile for ninety-degree parallel scoring or cuts is obsolete. Because this tool lays flat on the tile, being precise is possible. Scoring and cutting tiles that are even two foot square can be accomplished and sized by scoring the length of the tool and simply flipped over and finished.

### DRAWINGS

FIG. 1 Shows from a front view and FIG. 2 shows from an isometric view of a basic embodiment of the Tile Scoring-Cutting Guide being a triangular plate with a flat face with measurement numerals and correspondent measurement markings with a bar fence on one of the square right angle sides.

11. Measurement numeral markings along side of the other square right angle side of the bar fence.

12. Indicator measurement hash markings along the other square right angle side of the bar fence.

13. Flat and smooth edge of other right angle square side of the bar fence side creating a straightedge guide.

14. Horizontal parallel indicator measurement markings along diagonal straightedge side for sizing and designating distance right angle straightedge side is from bottom of tile being sized that that are slightly setback from edge.

15. Numeral measurement markings along edge of diagonal straightedge side.

16. Flat face of the triangular plate of the Tile Scoring-Cutting Guide embodiment.

17. Flat and smooth diagonal edge side creating a straightedge guide.

18. The T-bar fence elongated on one side of the right angle triangle wherein that it extends outwardly in a ninety-degree angle from said triangular plate.

FIG. 3 Shows from a front view and FIG. 4 shows from an isometric view and a preferred embodiment of the Floor Tile Scoring-Cutting Guide of the triangular plate with a flat face and measurement numerals and correspondent measurement markings with a T-bar fence on one of the square right angle sides.

19. Non-skid, non-slip surface attached to the face or embedded into the plate of triangular plate preferably made from a rubber material or other such material, creating a non-skid, non-slip surface to prevent the tool from movement while floor tile is being cut.

FIG. 5 Shows an isometric view of an optional embodiment of the Floor Tile Scoring-Cutting Guide of the triangular plate with a flat face and measurement numerals and correspondent measurement markings with a movable bar fence on one of the square right angle sides with the non-skid, non-slip surface.

20. The movable bar fence elongated on one side of the right angle triangle wherein that it extends outwardly in a ninety-degree angle from said triangular plate.

21. An indented and cut out slot on bar fence allowing for up and down movement.

22. The pinned screw in slot on the bar fence for a loose attachment to the triangular plate.

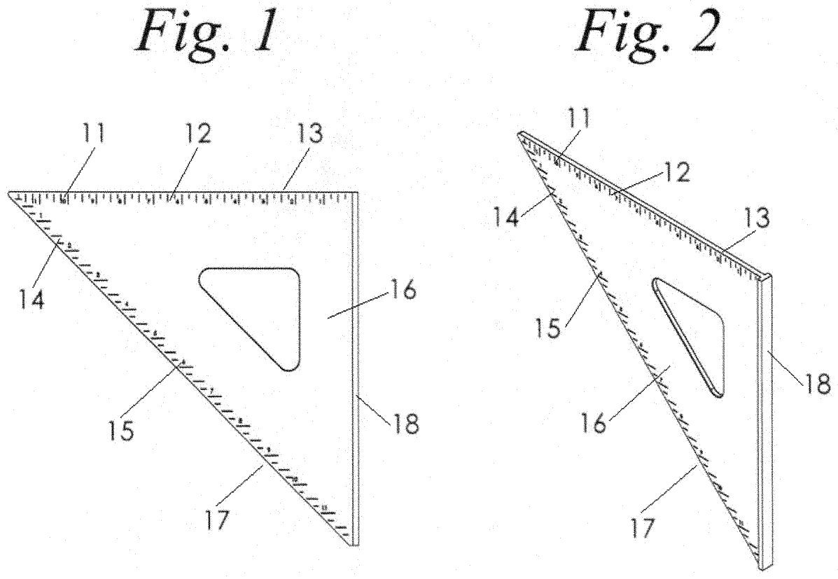

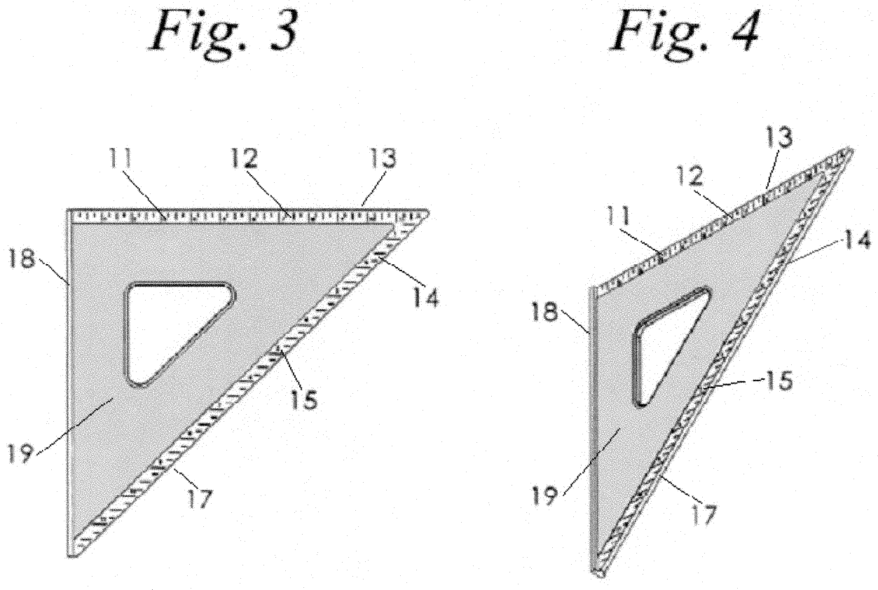

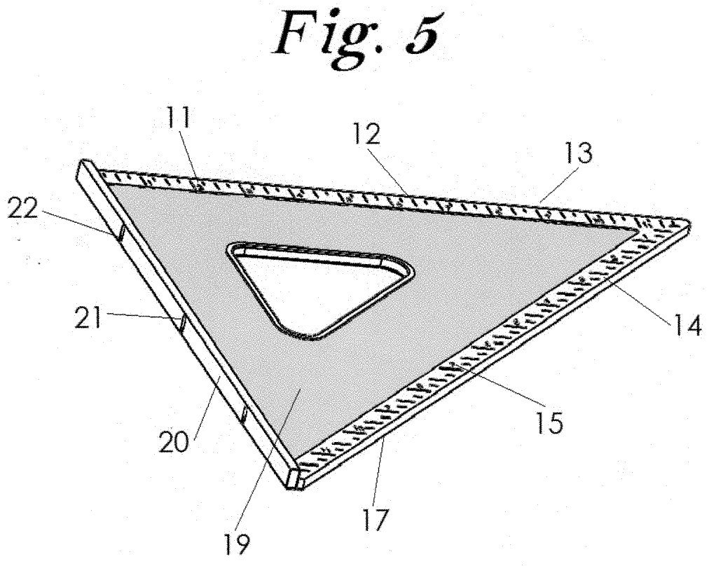

### DETAILED DESCRIPTION—FIG. 1 AND FIG. 2

The basic embodiment of the Floor Tile Scoring-Cutting Guide is a triangular plate with a flat face (16) with measurement numerals (11) (15) and corresponding measurement markings (12) (14) designating distance. Right angle straightedge side (13) and diagonal straightedge side (17) of the triangular plate (16) having flat and smooth sided edges creating a straightedge for a utility knife or other such apparatus to be drawn against as a guide. On the diagonal straightedge side (17) are numeral markings (15) and horizontal and parallel markings (14) that are corresponding to the right angle straightedge side (13) designating measurement distance right angle straightedge side (13) is from the bottom of the floor tile to be sized as well as corresponding with the length of the elongated bar fence (18). A preferred embodiment, measurement markings (14) (12) and numeral markings (11) (15) optionally are recessed, indented or slightly protruding markings. Such markings (12) (14) being a minimal distance from edge of right angle and diagonal straightedge sides (13) (17). The T-bar fence (18) extends outwardly at a ninety-degree angle from the said triangular plate and face (16) only a minimal distance and only far enough that Floor Tile Scoring Guide will lie flat on floor tile to be sized. The embodiment of the Floor Tile Scoring-Cutting Guide is manufactured from any form of an integrally formed solid material, preferably constructed of hard cased aluminum.

### FIG. 2 and FIG. 3—Preferred Embodiment

A preferred embodiment wherein on the face of triangular plate (16) having a non-skid and non-slide material (19) attached upon or embedded into the triangular plate and face (16) to hold Floor Tile Scoring-Cutting Guide firmly and securely in place. In the preferred embodiment of the Floor Tile Scoring-Cutting Guide it is manufactured from hard cased aluminum.

### FIG. 5—Optional Bar Fence

An optional embodiment with a bar fence (20) that has an elongated squared off rectangle bar that is separate from the body of the triangular plate (16) having indented and cut out slots (21) for loose attachment to triangular plate (16) by a pinned screw (22) that can be taken out for removal of the bar fence (20).

It is claimed:

1. A device made from an integrally formed triangle comprising of a thin plate with a flat face. Said plate having flat and smooth side edges on at least one right angle and the diagonal side, thus forming a straightedge as a scoring and or a cutting guide apparatus for floor tiles.

2. An apparatus of claim 1 comprising of an optional elongated T-bar fence extending outwardly in a ninety-degree angle from said face and plate on one side of the right angles.

3. Said T-bar fence of claim 2 extends only far enough to allow said plate to lay flat and securely on a floor tile unobstructed when abutted to an edge or lying just off of the edge of said floor tile.

4. An apparatus of claim 1 comprising of an optional elongated bar fence on one side of the right angles that extends outwardly at a ninety-degree angle from said triangle plate and face that is movable in an up and down ninety-degree direction from said plate and face that will allow entire tool to lay flat on a floor tile or drop down to be used as a fence when abutted to said floor tile.

5. The other said right angle and diagonal sides of claims 2, 3 and 4 comprising of flat and smooth surface edges to be used as a straightedge.

6. The said right angle straightedge side of claim 5 comprising of numeral and corresponding measurement hash markings indicating distance from bar fence.

7. The said diagonal straightedge side of claim 5 comprising of numeral and corresponding measurement hash markings indicating distance said right angle straightedge side is from the bottom of said floor tile.

8. The said diagonal straightedge side of claim 7 comprising of hash marks that are parallel and horizontal to right angle straightedge side.

9. The said right angle and diagonal straightedge sides of claims 6, 7 and 8 comprising of optional recessed, indented or slightly protruding notches that are set back a minimal distance away from said flat and smooth surface edges.

10. An apparatus of claim 1 comprising of an optional non slip-slide material that is attached upon or embedded into said triangular plate and face of at least one side of said triangular plate made of a rubber material or other non slip-slide material such as vinyl or leather or other non slip-slide material.

11. The constructed material of claim 1 comprising preferably of a hard cased aluminum or optionally constructed of any integrally formed material of metal, plastic or other solid material.
